(19) United States
(12) Patent Application Publication
(10) Pub. No.: US 2006/0190280 A1
(43) Pub. Date: Aug. 24, 2006

(54) Method and apparatus for management for use in fleet service and logistics

(75) Inventors: Louis J. Hoebel, Burnt Hills, NY (US); Carol L. Kiaer, Argyle, NY (US); Marc Garbiras, Clifton Park, NY (US)

Correspondence Address: WILLIAMS, MORGAN & AMERSON, 10333 RICHMOND, SUITE 1100, HOUSTON, TX, 77042, US

(73) Assignee: Lockheed Martin Corporation

(21) Appl. No.: 11/137,074

(22) Filed: May 25, 2005

Related U.S. Application Data
(60) Provisional application No. 60/655,507, filed on Feb. 22, 2005.

(51) Int. Cl. G06Q 99/00; G06F 15/02; G06F 9/46

(52) U.S. Cl. 705/1; 705/9

(57) ABSTRACT

An apparatus and a method for managing a fleet of assets and their associated logistics are disclosed. The apparatus includes an Autonomic Product Support (“APS”) system, a simulator, and fleet data including logistical data. A user can interact with the fleet data to make management decisions both in maintenance and operations through the APS system, including simulations on the simulator of what-if scenarios to determine preferred courses of action.

### BACKGROUND OF THE INVENTION

1. Field of the Invention

The present invention pertains to fleet management and, more particularly, to a method and apparatus for use in fleet service and logistics.

2. Description of the Related Art

As corporations move toward complete life-cycle support contracts, decision-making and maintenance productivity tools to effectively manage assets from “cradle to grave” become important components to success and profitability. Proactive approaches to the management of such contracts are significant elements to ensuring that contract obligations and incentives are met, over the life of the contract. This includes extensive configuration management and electronic obsolescence management capabilities. Integral to the effectiveness and usefulness of such decision support components is their ability to support open and free information exchange between business units, trading partners, suppliers, contractors, and customers. Tools, applications, and data should conform to open architecture principles, for maximum integration and interoperability with other external systems.

Those responsible for maintaining the supply chain and the management of logistical operations associated with it establish business rules, procedures, and metrics to support such activities. These policies and constraints define the nature and frequency of maintenance actions, part replenishment, and configuration updates, to name a few. The data and information used to effectively manage and execute these operations can be vast and overbearing. The ability of the application to quickly collect, construct, and effectively deliver information in support of these functions enhances one's ability to make a timely, accurate, and informed decision. Additional analysis, prediction, and assessment tools provide decision makers with capabilities to prepare and act on future events, while controlling current situations.

Thus, one difficult logistical problem is the efficient utilization of resources in the support and maintenance of large fleets of assets. Large fleets of assets may be found in both civilian and military contexts. In a military context, a navy may have a large number of vessels distributed widely about the globe. The navy may also have resources distributed about the globe to service and maintain the fleet of vessels. However, these problems arise in civilian contexts as well. The closest analog would be shipping companies, with vessels coursing commercial shipping lanes about the globe and needing servicing and maintenance as they do so. However, such fleets are not limited to sea-going vessels. For instance a navy might have aircraft in addition to vessels. Also, shipping companies might have large numbers of heavy-duty trucks for shipping cargo across land widely distributed across a land mass.

Keeping large fleets of assets in operation efficiently is a complicated task. Increasingly, maintenance and logistics contracts for such fleets are based on performance metrics rather than service metrics. For instance, rather than specifying a turnaround time for repairs, the contracts call for fleet management, often of large fleets, to ensure a high level of availability. This trend is also tending to be over the life of a contract, fleet or asset. This makes individual decisions into global reasoning events over an extended period of time.

Existing logistics management techniques, such as remote diagnostics, are focused on facilitating the speedy return to service of an individual asset; as such, they are aimed at improving service metrics. Overall fleet management invokes a broader view of a potentially large population, with complex interactions, over a long and uncertain horizon. The complex interactions and uncertain horizon demands stochastic tools such as simulation. However, standard, discrete-event simulation bogs down with long planning horizons, or with large populations. Fleet management involves both long planning horizons and large populations, limiting the practicality of applying such simulation.

Deciding when and how to implement a new strategy in fleet support and maintenance is not a static enterprise decision but a context dependent decision process. Further, it is based on the expected outcome of implementing that strategy in the current context as described by the performance metrics. Data analysis and visualization are used more frequently in business processes due to their effectiveness in conveying information and in developing a context-dependent picture for users. Maintenance and service data are especially convenient for cases where current information is to be utilized over time for different uses within multiple processes and by different users. The problem that arises is navigating this information for effective use. Generating new or random strategies based on fleet average or specific instance data is unlikely to tie outcomes (i.e., metrics) to policies (i.e., application of strategies to instances).

Decision support has long been used to assist maintainers. Monitoring and diagnostic systems are decision support tools that look at a single piece of equipment and assist the user to determine what should be done to bring the equipment back to a usable state. While such tools are valuable, their focus on a single item is an important limitation. If two pieces of equipment are competing for a resource (e.g., personnel, parts, space in the repair facility, etc.) there may be no information readily available to support a decision to repair one or the other.

Decision support tools provide subject matter experts with the information necessary to make informed decisions in support of their various roles and responsibilities. Relevant data is brought together from dispersed sources and concise assessments of situations, activities, and trends are presented. Much of the information retrieval is transparent to the user, and summaries or context sensitive information reports are automatically gathered and generated by the system. Statistical analysis and traditional data mining techniques are often applied to such repositories of information, in order to produce the insightful summaries and extract relevant feature points from the information. Correlations and relationships between data sets become exposed and more knowledge about the underlying data is gained. Visualization techniques are employed to present those results as clear, concise, summaries to users.

While many decision support systems exist with these capabilities, they have their limitations. Most use classic statistical analysis methods and data mining techniques to determine information relevance and feature selection of anomalous data. Often this type of analysis is very resource intensive and must be done off-line, and the presentation of results is not always interactive, not allowing users to change parameters or settings and further “mine” the information for a broader or more specific context. Also the solutions found are returned and presented without any supporting evidence associated. That is, users are supposed to trust the results obtained blindly.

The present invention is directed to resolving, or at least reducing, one or all of the problems mentioned above.

### SUMMARY OF THE INVENTION

The invention comprises, in various aspects and embodiments, an apparatus and a method for managing a fleet of assets and their associated logistics.

In a first aspect, the invention includes a fleet management and logistics system, comprising: an autonomic product support system capable of graphically presenting fleet data including logistical data regarding at least one asset within a fleet over time in a graphically navigable form to a user; a simulator capable of simulating the effect over time of a prospective management decision regarding the asset over time and upon request of the user through the autonomic support system; and a communications link over which the user interfaces with the fleet data through the autonomic product support system.

In a second aspect, the invention includes a computing system, comprising: a software-implemented fleet management and logistics system, including: an autonomic product support system capable of graphically presenting fleet data including logistical data regarding at least one asset within a fleet over time in a graphically navigable form to a user; and a simulator capable of simulating the effect over time of a prospective management decision regarding the asset over time and upon request of the user through the autonomic support system; a user station through which the user interfaces with the autonomic product support system of the fleet management and logistics system; and a communications link over which the user interfaces with the fleet data through the autonomic product support system.

In a third aspect, the invention includes a program storage medium encoded with instructions comprising an autonomic product support system capable of graphically presenting fleet data including logistical data regarding at least one asset within a fleet over time in a graphically navigable form to a user, including: a data access module responsible for extracting information from at least one data source and creating data access objects with the information; an information composition and analytics module responsible for analyzing and composing the data access objects into at least one data set; an application controller module that delegates authority to the a plurality of function tools within the information composition and analytics tier based upon received requests from the user; and a presentation module capable of rendering the analyzed and composed data into a graphical form and presenting the rendered data to the user.

In a fourth aspect, the invention includes a computing apparatus, comprising: a processor; a bus system; a storage that communicates with the processor over the bus system and on which reside: an autonomic product support system capable of graphically presenting fleet data including logistical data regarding at least one asset within a fleet over time in a graphically navigable form to a user; and a simulator capable of simulating the effect over time of a prospective management decision regarding the asset over time and upon request of the user through the autonomic support system.

In a fifth aspect, the invention includes a system, comprising: a fleet of assets distributed across a theatre of operations; a computing system, including: a plurality of user stations through which a plurality of users may manage the assets of the fleet; an autonomic product support system graphically presenting fleet data including logistical data regarding the assets over time in a graphically navigable form to the users; a simulator capable of simulating the effect over time of prospective management decisions regarding the assets over time and upon request of the users through the autonomic support system from the user stations; and a communications link over which the users interface with the fleet data through the autonomic product support system and over which fleet data can be collected from the fleet.

In a sixth aspect, the invention includes a method for managing a fleet of assets and their associated logistics, comprising: presenting to a user in a graphically navigable form a current state for at least one asset of the fleet and at least one navigable choice for accessing additional logistical information regarding the at least one asset; receiving an input from the user selecting a navigable choice; and presenting to the user in a graphically navigable form the additional logistical information.

In other aspects, the invention includes a program storage medium encoded with instructions that, when executed, perform such a method and a computing apparatus programmed to perform such a method.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one particular embodiment of a system in accordance with the present invention;

FIG. 2 depicts one particular implementation of the management computing system of the system of FIG. 1;

FIG. 3 is a block diagram of a user station in the management computing system of FIG. 2;

FIG. 4 conceptually illustrates one particular implementation of the autonomic product support system of the management computing system of FIG. 2;

FIG. 5 is a block diagram of a framework implemented by the autonomic product support system of FIG. 4;

FIG. 6A is a display screenshot of a report from the APS application where a decision maker is presented with information about the different configurations of the managed assets, including number and location of configurations, similarities, and distinctions among them, and a recommendation on how to reduce the total number of configurations of the assets;

FIG. 6B is a screenshot of a report layout providing a listing of the information driving the report and the key attributes for each report domain summarized and aggregated graphically in one particular embodiment;

FIG. 7 is a high level, block diagram of the simulator in one particular embodiment;

FIG. 8A-FIG. 8B illustrate alternative semi-Markovian processes for use in the simulator of FIG. 7;

FIG. 9 illustrates regional groupings in the assets of the fleet of FIG. 1 in one particular embodiment; and

FIG. 10 illustrates a method practiced in accordance with one particular embodiment of the present invention.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

FIG. 1 conceptually illustrates one particular embodiment 100 of the present invention. In the embodiment 100, a fleet 103 of assets 106 (only one indicated) is shown in a theater of operations 109. The tasks performed by the assets 106 will be implementation specific, and a function of a number of factors such as the type of asset and the operational status of the asset. Note that these factors might vary among the assets 106. The assets 106 form a tactical data net 112 over which data may be collected and transmitted to a management computing system 115 over a communication channel 118.

The assets 106 are, in the illustrated embodiment, vehicles such as ocean-going vessels, aircraft, spacecraft, or heavy-duty trucks. Note, however, that this is not necessary to the practice of the invention. For instance, the assets 106 may be mobile computing resources or communications devices in alternative embodiments. Furthermore, in some embodiments, the assets 106 may display considerable variation in type within the definition of the fleet 103. For example, if the assets 106 include vehicles, the assets 106 may also include repair, refueling, and/or cargo lading facilities that service the vehicles. Thus, the invention admits wide variation in the implementation of the assets 106 and the composition of the fleet 103, which need not be homogenous.

The number of assets 106 and the scope of the theatre of operations 109 will also be implementation specific. In general, the invention contemplates relatively large numbers of assets 106 and a wide theatre of operations 109. For example, the fleet 103 and theatre of operations 109 may comprise several hundred vehicles operating across the globe. The invention contemplates this scale because it is at this scale at which the greatest benefit from the invention's implementation may be reaped. However, this scale is not necessary to the practice of the invention. The invention may also be employed with relatively smaller numbers of assets 106 over a more limited geographic scale. For instance, the invention is equally applicable to fleets 103 comprising a couple of dozen assets 106 in a theatre of operations 109 covering several square miles.

The scope of the theatre of operations 109 will affect the implementation of the tactical data net 112 and the communications channel 118. In the illustrated embodiment, the assets 106 are shown to be networked, implying that the assets 106 are either computing resources or are equipped with a computing device. Note that this is not necessary to the practice of the invention, since the tactical data net 112 may comprise computing devices associated with, but not necessarily on or in, the assets 106. For instance, a computing device located in a repair facility might relay information about a vehicle undergoing repair in that facility. Nevertheless, the computing devices (not shown) associated with the assets 106 that define the tactical data net 112 will typically be distributed across a geographic scope reasonably commensurate with that of the theatre of operations 109.

It is also contemplated that, in some embodiments, the geographic scope of the tactical data net 112, as well as the theatre of operations 109, may change over time. For instance, if the assets 106 of the fleet 103 are mobile, and if the computing devices of the tactical data net 112 are embedded in the assets 106, the geographic scope of the tactical data net 112 and the theatre of operations 109 will be quite fluid. As the assets 106 of the fleet 103 concentrate, the scope may become quite small. As the assets 106 disperse, the scope may become quite large. If the assets 106 are very mobile, this fluidity might be manifested in quite short periods of time.

These types of considerations also affect the implementation of the communication channel 118. In the illustrated embodiment, the communication channel 118 comprises a communications satellite 121, satellite links 124 from the management computing system 115 to the communications satellite 121, and satellite links 127 from the satellite 121 to the assets 106. This particular implementation is apt for widespread tactical data nets 112 and theatres of operation 109 that are quite large and/or assets 106 that are highly mobile. However, where the assets 106 or the computing devices associated with them are not mobile and are located over a relatively limited geographic scope, the communication channel 118 might be implemented using, for example, landlines.

Note that one of the satellite links 127 is directly to one of the assets 106, thereby effectively bypassing the tactical data net 112. In some embodiments, communications between the fleet 103 and the management computing system 115 may be conducted completely through the tactical data net 112. In some embodiments, the management computing system 115 may communicate with select assets 106 directly and the rest of the fleet 103 through the tactical data net 112. Some embodiments might omit the tactical data net 112 completely. In these embodiments, all communications would be between the management computing system 115 and the assets 106 directly.

However, the tactical data net 112 will typically provide additional advantages with respect to fleet management and operation not germane to the present invention, and so most embodiments will employ one. Considerations associated with these other advantages will usually drive the design of the tactical data net 112, such as the topology, protocol, and architecture of the tactical data net 112. These aspects of the implementation of the tactical data net 112 are not material to the practice of the invention.

The management computing system 115 includes a plurality of user stations 130, an Autonomic Product Support (“APS”) system 133, a simulator (“SIM”) 136 and a plurality of data stores 138. The management computing system 115 also includes a plurality of communications links 140 among the user stations 120, the APS 133, the simulator 136, and the data stores 138. The data stores 138 contain, among other things, data regarding the fleet 103 (i.e., “fleet data”) and implementation specific details of its operation, maintenance, etc. A user (not shown) interacts with the fleet data at a user station 130 through the APS system 133. The data stores 138 also contain tools (not shown) used by the APS system 133 and the SIM 136 in a manner described more fully below.

The APS system 133 extracts and organizes information from the data stores 130 responsive to requests from the user. One type of interaction is to graphically navigate through the data to facilitate an understanding of the context currently being explored. Another form of interaction is to simulate “what-if” scenarios with the SIM 136 (through the APS system 133) to evaluate potential strategies for acting within the current context. In some embodiments, a selected strategy may be implemented with the fleet 103.

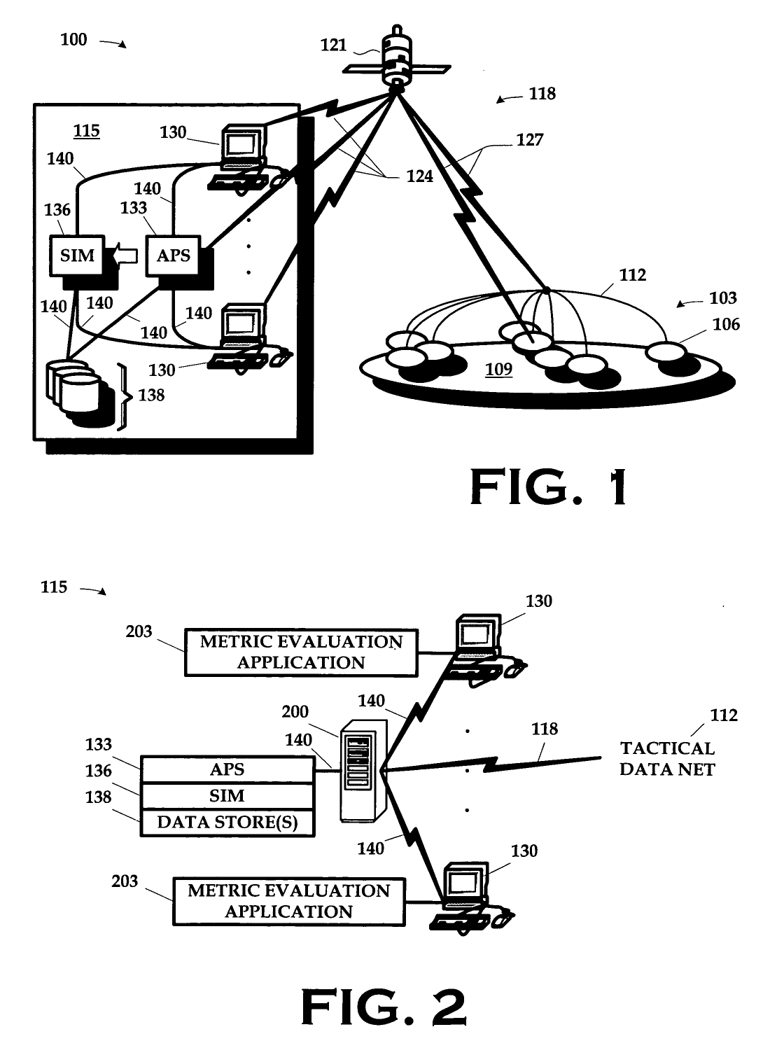

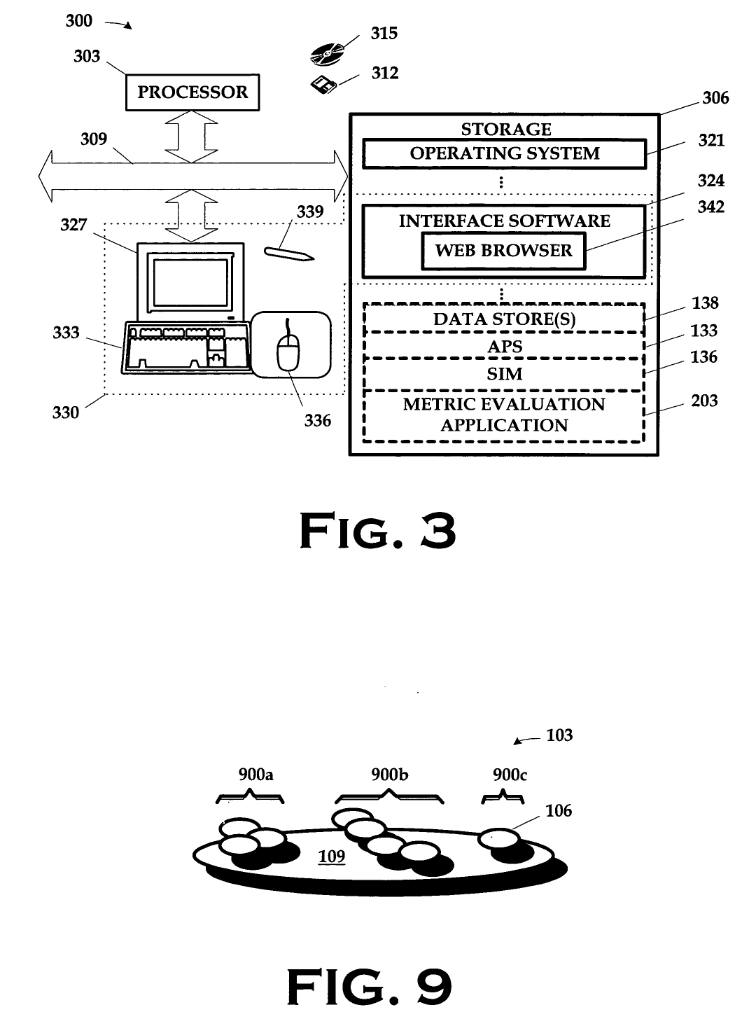

Turning now to FIG. 2, the management computing system 115 may include any number of user stations 130, although most embodiments will employ a number that is somewhat proportional to the number of assets 160 in the fleet 103. The management computing system 115 is, in the illustrated embodiment, a network employing a client/server architecture. Other networking architectures may also be employed in alternative embodiments. Accordingly, the management computing system 115 is a distributed computing system. However, in alternative embodiments, the management computing system 115 may be implemented in a centralized fashion. For example, the user stations 130 may be implemented as time sharing terminals linked to a host, mainframe computer (not shown).

The user stations 130 are implemented as work stations in the illustrated embodiment and, along with a representative server 200, comprise the network. The APS system 133 and the simulator 136 are shown resident on the server 200 although they may reside on any computing apparatus in the management computing system 115. The APS system 133 and the simulator 136 are, therefore, server applications in this particular embodiment. A metric evaluation application 203, whose function will be discussed further below, resides on each user station 130. These are therefore client applications in the illustrated embodiment. The management computing system 115 also includes a number of data stores 138, whose function will also be discussed further below, shown residing on the server 200.

The data stores 138, shown in both FIG. 1 and FIG. 2, may be populated with the fleet data in a variety of ways. For instance, the data stores 138 may be populated with operational and/or maintenance data pushed to the management computing system 115 or pulled from the tactical data net 112. The data stores 138 may be populated with data manually entered at, e.g., a user station 130. Or, the data may be imported from pre-existing data stores (not shown) residing on other computing systems. Typically, the data stores 138 will be populated using some combination of these techniques. Note, however, that still other, alternative techniques may be employed. The data stores 138 may be populated in any suitable manner known to the art. The present invention is not limited by the manner in which the data stores 138 are populated.

FIG. 3 is a block diagram of a computing apparatus such as may be used to implement a user station 130 or the server 200 in the management computing system 115 of FIG. 2. FIG. 3 depicts, in a block diagram, selected portions of the computing apparatus with which the user station 130 is implemented. The user station 130 includes a processor 303 communicating with storage 306 over a bus system 309. In general, the user station 130 will handle a fair amount of data, and some of it will be graphics, which is relatively voluminous by nature. Thus, certain types of processors may be more desirable than others for implementing the processor 305. For instance, a digital signal processor (“DSP”) or graphics processor may be more desirable for the illustrated embodiment than will be a general purpose microprocessor. Other video handling capabilities might also be desirable. For instance, a Joint Photographic Experts Group (“JPEG”) or other video compression capability and/or multi-media extension may be desirable. In some embodiments, the processor 305 may be implemented as a processor set, such as a microprocessor with a graphics co-processor, particularly for server architectures.

The storage 306 may be implemented in conventional fashion and may include a variety of types of storage, such as a hard disk and/or random access memory (“RAM”). Some embodiments might also include removable storage such as the magnetic disk 312 and the optical disk 315. The storage 306 will typically involve both read-only and writable memory implemented in disk storage and/or cache. Parts of the storage 306 will typically be implemented in magnetic media (e.g., magnetic tape or magnetic disk) while other parts may be implemented in optical media (e.g., optical disk). The present invention admits wide latitude in implementation of the storage 306 in various embodiments.

The content of the storage 306 will depend to some degree on whether the computing apparatus 300 is used to implement the server 200 or one of the user stations 130, both shown in FIG. 2. For instance, if the computing apparatus 300 is implementing the server 200, the storage 306 is encoded with the data stores 138, the APS system 133, and simulator 136. If the computing apparatus 300 is implementing a user station 130, then the storage 306 will be encoded with a metric evaluation application 203.

The storage 306 is also encoded with an operating system 321 and some interface software 324 that, in conjunction with the display 327, constitute an operator interface 330. The display 327 may be a touch screen allowing the operator to input directly into the user station 130. However, the operator interface 330 may include peripheral input/output (“I/O”) devices such as the keyboard 333, the mouse 336, or the stylus 339. Similarly, the interface software 324 may include drivers and associated software (not shown) for these peripheral I/O devices. The processor 303 runs under the control of the operating system (“OS”) 321, which may be practically any operating system known to the art. Exemplary, commercially available operating systems suitable for implementing the OS 321 include, but are not limited to, DOS, WINDOWS, LINUX, and OS/2. The processor 303, under the control of the operating system 321, invokes the interface software 324 on startup so that the operator (not shown) can control the user station 130.

In the illustrated embodiment, the interface software includes a web browser 342. The web browser 342 is a software application used to locate and display Web pages, i.e., computer readable files, or documents, formatted in hypertext markup language (“HTML”) such as is used on the World Wide Web of the Internet. Exemplary, commercially available web browsers suitable for implementing the web browser 342 include, among others, NETSCAPE NAVIGATOR, MICROSOFT INTERNET EXPLORER, and MOZILLA FIREFOX. These are graphical browsers, which means they can display graphics as well as text. In addition, most browsers can present multimedia information, including sound and video, though they require plug-ins for some formats. Each of these capabilities may be desirable in one or more embodiments of the present invention.

Note that several components of the system described above are software-implemented. Some portions of the detailed descriptions herein are consequently presented in terms of a software-implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software-implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

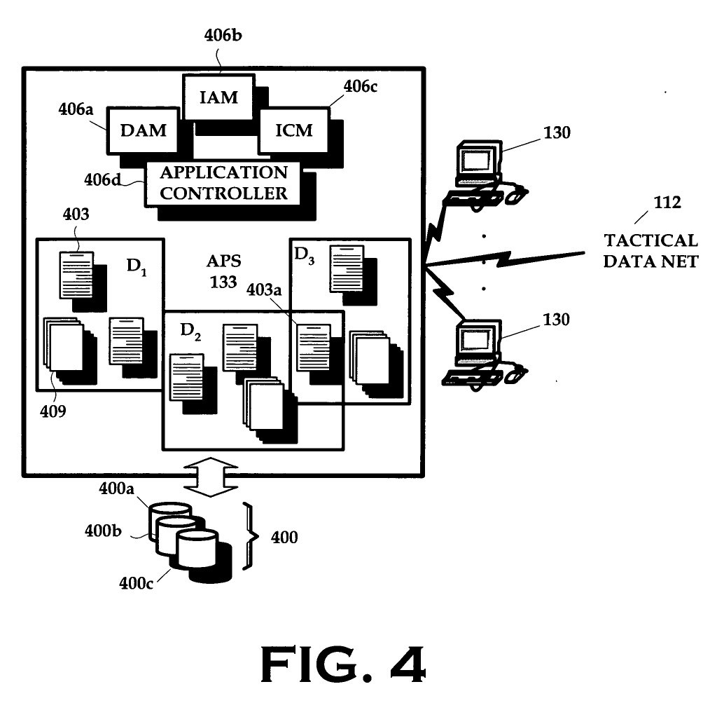

Turning now to FIG. 4, the APS system 133 is conceptually illustrated in better detail. APS system 133 is a decision support framework and system for system life-cycle support. The APS system 133 utilizes fleet data in the form of the information 400, such as operational, service, and maintenance data 400a-400c, to compose information sets 403 (only one indicated) within a graphical navigation environment. The information 400 may stored, for instance, in the data stores 138 or may be, for example, pushed or pulled from the tactical data net 112 in real-time or near real-time. In general, however, it is expected that the information 400 will have been previously acquired and stored.

The APS system 133 provides the visual information sets 403 containing relevant information from across asset life-cycle phases in support of the operation and sustainment of mechanical assets. These information sets 403 may include situational assessment and recommended course of action, and provide links or access to supporting information used in formulating any hypotheses. This information is used, in the illustrated embodiment, by maintainers and controllers of various levels for supporting their operations and business process decisions.

More particularly, the APS system 133 organizes the information sets 403 by context in which it will be presented to the user and by a domain in which the user may be operating. For instance, the user might be viewing data in the context of the fleet 103, a group of assets 106 within the fleet 103, or a single asset 106. The user might be viewing data pertaining to parts for the vehicles, maintenance time, asset availability, maintenance analysis, etc. Each of these may be considered a “domain” in which the user may operate. The APS system 133 in the illustrated embodiment is shown defining three domains D₁, D₂, D₃ into which the information sets 403 are segregated. Note that one information set 403a is in both domains D₂, D₃. The number and definition of domains in any given embodiment will be implementation specific and the invention is not limited thereby.

Thus, the user selects a context and a domain in which to begin operating relative to the management of the fleet 103. The user's selection is a request to the APS system 133 to present certain of the information 400. The APS system 133 assembles the information and presents it by displaying a “report” to the user. To this end, the APS system 133 maintains a set of “forms” 409 (only one indicated) for each of the domains D₁, D₂, D₃. The forms 409 are essentially blank templates that define the information that may be presented in a given context. Upon receiving the request from the user, the APS system 133 populates the appropriate form 409 within that domain and for that particular context using the information sets 403.

The APS system 133 then renders the populated forms 409 into a second report that is then displayed to the user. Any given report may contain one or several populated forms. The format into which the populated forms 409 are rendered for display will be implementation specific and may be chosen from a wide array of formats. At least some of the information that is presented to the user is “navigable”, i.e., represents a link to another report. The link may represent a change in context, with a concomitant change in information, or to additional or different information regarding the current context. Note that, in the illustrated embodiment, the user may navigate through the data across contexts, but not across the domains D₁, D₂, D₃.

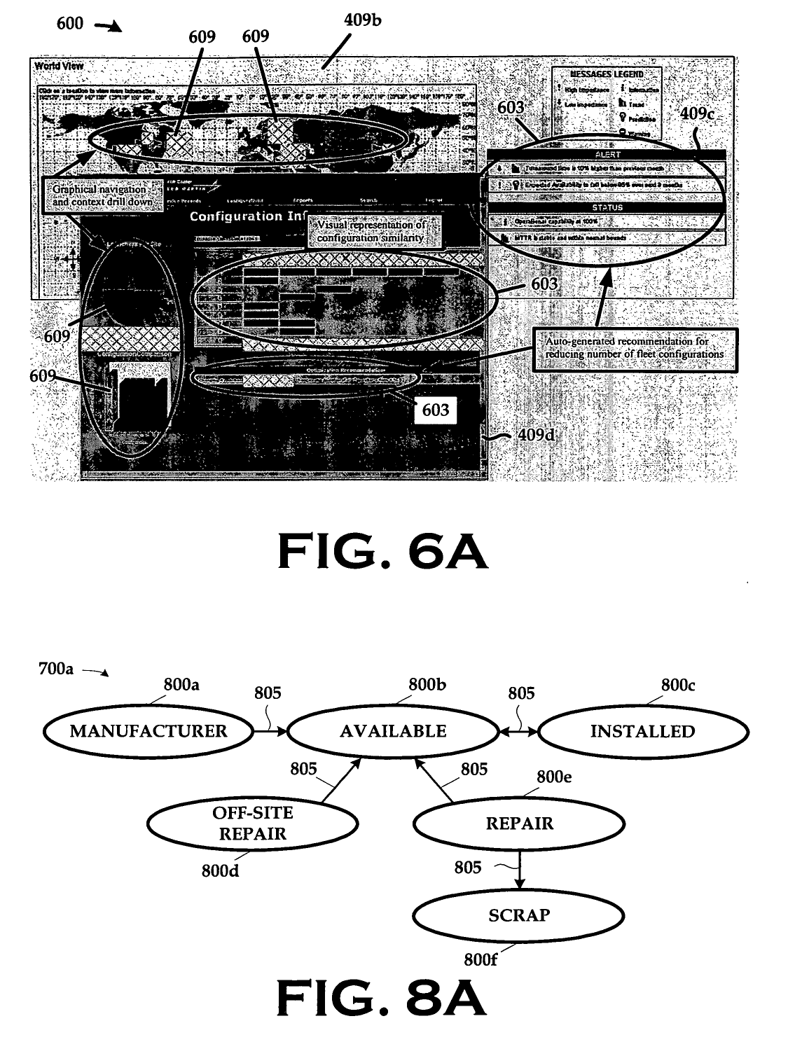

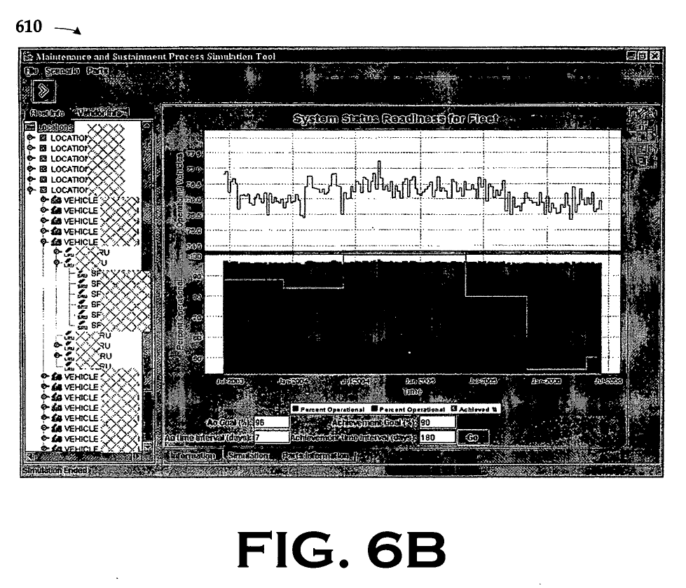

For instance, consider the display 600 in FIG. 6A. The display 600 presents information about the different configurations of the managed assets, including number and location of configurations, similarities, and distinctions among them, and a recommendation on how to reduce the total number of configurations of the assets. The display 600 is a graphical rendering of at least three forms 409b, 409c, 409d. The form 409b provides an image indicating distribution and location of various assets 106 of the fleet 103. The form 409c provides operational information, i.e., alerts and status pertaining to the assets 106 in a tabular format. The form 409d provides information in a graphical format regarding the configuration of selected assets 106. Note that the forms 409c, 409d both include un-navigable objects 603 while the forms 409b, 409d include navigable objects 606.

All the information in the display 600 comes from a single domain, e.g., parts for the vehicles, maintenance time, asset availability, or maintenance analysis. The user cannot change the context of the session directly into another domain from this display 600. However, the user can change the current context to drill up or down within the domain by selecting one of the navigable objects 606. In the illustrated embodiment, the navigable objects 606 are all graphical objects (i.e., icons), but may also be, for example, hyperlinks. By selecting one or more of the navigable objects 606, the user can access a new report, such as the one in the display 610 in FIG. 6B. The display 610 provides a listing of the information driving the report and the key attributes for each report domain summarized and aggregated graphically in one particular embodiment

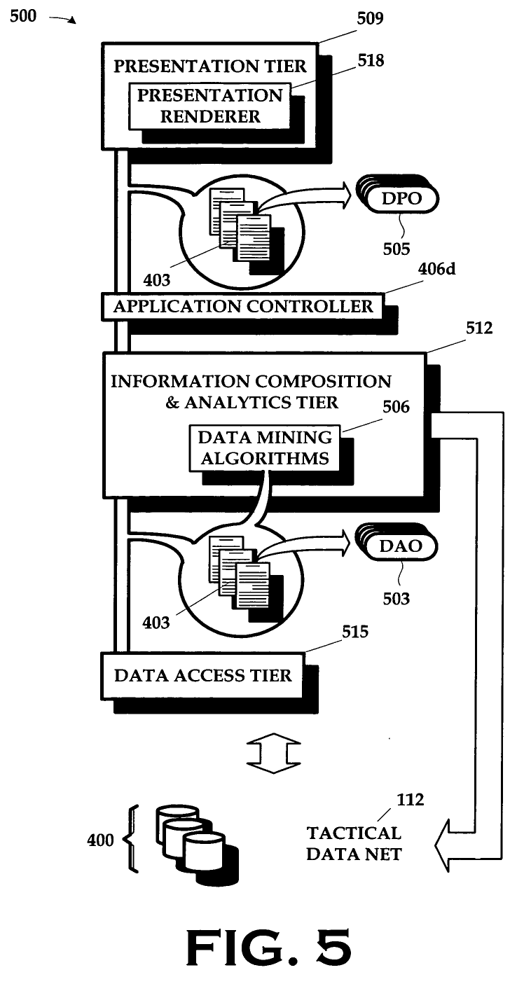

The APS system 133 therefore provides access to information 400 of interest to decision makers of various roles and responsibilities. The information 400 is, in the illustrated embodiment, stored in the data stores 138, shown in FIG. 2. The information may include, for instance, operational data 400a, service data 400b, and maintenance data 400c. Note that the type and nature of the information will be implementation specific, as will be the manner in which it is stored. Thus, alternative embodiments may use information other than the operational data 400a, the service data 400b, and the maintenance data 400c in addition to or in lieu of the information 400. The APS system 133 system described includes a number of modules 406a-406c that interact to provide the realized benefits of the APS system 133 in total. The modules 406a-406c implement the exemplary framework 500, shown in FIG. 5, in a manner described further below.

The APS system 133 implements a framework, such as the framework 500 shown in FIG. 5, for the information composition and navigation described above. The framework 500 comprises a presentation tier 509, an information composition and analytics tier 512, and a data access tier 515 in addition to the application controller 406d. The presentation tier 509, information composition and analytics tier 512, and data access tier 515 are the implementations of the information composition module 406c, the information analytics module 406b, and the data access module 406a, respectively.

The core of the framework 500 of the illustrated embodiment stands firmly on open standards and open source technologies, although alternative embodiments may adopt different approaches. The use of software tools and components that adhere to open standards should impart longevity and long term effectiveness of the APS system 133. The use of widely supported conventions should permit components, possibly from different vendors or sources, to be easily integrated in and out of the APS system 133 as needed or desired. This approach will also be useful in adapting to new functionality and integration with emerging technologies. Such an advantage is further enhanced by the use of open source software to help with the development and delivery of needed functionality. Open source software lets the developers leverage worldwide community support during the design, development and deployment phases of the application. This will be helpful for researching new technologies for integration into the APS system 133 and for times when new developers are brought in to revise or append to the application.

The open architecture shown in FIG. 5 is a web-tier application for APS based on the “Struts framework”, published in Don Denoncourt, “Struts: A Standard Architecture for Web Applications”, e-Pro Magazine, April 2002. The Struts framework implements what many people call, the Model 2 approach, see TurboM2, “TheModel2 Architecture”, http://www.turbom2.orgidocs/Model2Architecture.pdf. The Model 2 architecture is a variation of the Model View Controller design paradigm, see Inderjeet Singh, Beth Steams, Mark Johnson, “Designing Enterprise Applications with the J2EE Platform, Second Edition”, Chapter II, in which the “control” aspect of the design is centralized as opposed to the Model 1 implementation where it is decentralized. The Model 2 architecture provides a single point of control for security, logging, and process flow. Much of the code is also reusable and easily reconfigured in this framework.

Referring now to both FIG. 4 and FIG. 5, the APS system 133 includes a data access module (“DAM”) 406a, shown in FIG. 4, that implements the data access tier 515 of the framework 500, shown in FIG. 5. Within the framework 500 defined by the APS system 133, the data access module 406a extracts the information 400 from data sources such as the tactical data net 112 and the data stores 138. The data access module 406a also creates data access objects (“DAO”) 503, shown in FIG. 5, with the extracted information. The data access objects 503 are defined through object relationships within the framework 500 and are actionable objects representing that data that the APS system 133 can manipulate.

Although the context navigation is handled by the framework 500, the data access objects 503 define themselves as navigable or un-navigable. Navigable data access objects 503 define their interaction scheme within the information set 403. Navigating context is analogous to changing data retrieval query parameters, or navigating from one information set 403 to another.

Referring again to both FIG. 4 and FIG. 5, the APS system 133 also includes an information analytics module (“IAM”) 406b that implements the information composition and analytics tier 512. The LAM 406b defines and discovers relationships between data and designs the content of the information sets 403 through a plurality of data mining algorithms 506. In the illustrated embodiment, the data mining algorithms 506 therefore comprises a part of the information composition and analytics tier 512. Typically, these data mining algorithms 506 run offline or during periods of low usage. The data mining algorithms 506 run over the various data sources to discover “interesting” features and trends, and to calculate metrics of interest and inherent relationships. These data mining algorithms 506 persist their results, which the framework 500 accesses and displays within appropriate context based information sets 403 to the user. Thus, the information analytics module 406b defines and discovers relationships between data and is responsible for designing the content of the information sets 403.

The information composition module (“ICM”) 406c assembles the data retrieved by the data access module 406a for a given information set 403 defined by the information analytics module 406b. The ICM 406c is also used in implementing the information composition and analytics tier 512. The ICM 406c decides how each data access object 503 should be rendered and displayed by defining the appropriate form 409 for each application context that will be presented to a user. More particularly, the form 409 specifies which information content is accessible, how it is accessible (e.g., the format in which it is stored), and how it is rendered (e.g., in tabular form, as free text display, or a graphical object). Intuitive extrapolations and summaries of information are rendered in graphical form to users, allowing them to see relationships and correlations within the data. The information is interactive, allowing users to refine the context of information easily and responsively, through simple point and click interaction over the areas of interest.

The composition includes at least some rendering of the at least some of the information as graphical navigation components, so that the context of the information set 403 can be changed through user interaction. The presentation tier 509 of the framework 500, discussed further below, is responsible for rendering the actual graphical display, but the form 409 contains the raw data to be displayed. The graphical presentation of information is actually performed by a presentation renderer 518, which is implemented using open source third party tools in the illustrated embodiment.

One particular embodiment renders the information using KAVACHART, commercially available from:
Visual Engineering, Inc.
164 Main St, Second Floor
Los Altos, Calif. 94022
ph: 650 949-5410
fax: 650 949-5578
email: info@ve.com
Internet: www.ve.com
   or JFREECHART, available from for download, subject to conditions and limitations, from www.jfree.org. The rendered information can be presented using, for example, the STRUTS package available from:
The Apache Software Foundation
1901 Munsey Drive
Forest Hill, Md. 21050-2747
U.S.A.
fax: +1.410.803.2258
e-mail: apache@apache.org
http://struts.apache.org/
   or the Common Development Framework.

In addition to the information itself, the form 409 also contains meta-information used by the presentation renderer 518 in order for it to produce image maps that, in the illustrated embodiment, constitute the reports discussed above by which the information is presented to the user. The meta-information includes the request path information (or request attribute information) to associate with a specified graph data element. The image maps define the polygonal boundaries of the graph series, and these polygons are given request paths (or hyperlinks) so that a user can click on the polygons and create a new request for information, such as a drilldown to more specific information. These requests are sent to the application controller 406d.

The coordination between the user interaction of modules 406a-406c and the corresponding context changes is the responsibility of the APS system 133 application controller 406d, which maps information set 403 relationships and describes context change parameters within a scope. Requests to the application controller 406d include a description of the desired information context (or, the “context path”) and parameters used to customize the information set and/or its display. Information contexts are defined as different servlet views (not shown). A servlet view in this particular embodiment is (1) a Struts Action class, as described above, which processes the incoming request, (2) a data form that holds the processed information from the action, and (3) a definition of what or where to pass the data form. The determination of which servlet view to employ is, in this particular embodiment, a function of user preferences, context level, and the data available for presentation.

A separate servlet view is implemented for each contextual information set that can be displayed to a user. The application controller 406d delegates authority to the modules 406a-406c, based upon received requests. The application controller 406d holds the knowledge of which modules 406a-406c work together to produce information for a specific context, or report. Each servlet view defines which method or procedure of the data access module 406a invoke is invoked or called to retrieve data, and the analysis routine to which the data is passed. The application controller 406d maps the results of the analysis routine to the ICM 406c form 409 for the servlet view, and returns the form contents to the presentation tier 509 for rendering.

The APS application controller 406d is implemented as the Struts configuration file, which maps the incoming request path to a servlet view. The ICM 406c is implemented in a number of Struts Action classes. From within these Action classes the appropriate data access objects 503 are interfaced with, and additional analysis modules are called, as defined by the Action class. The Action class populates the data form 409 associated with it (defined by the application controller 406d in the configuration file), and the application controller 406d passes the populated data form 409 to the configured recipient, e.g., the image map that will present the report to the user.

Returning to FIG. 5, the presentation tier 509 renders the results of the application to the Web browser 342, using the Struts framework and provides for visual data navigation. Thus, in the illustrated embodiment, the data is rendered into a Web page or, more technically, a Java Server Page (“JSP”). JSP is a server-side technology, JSPs are an extension to the Java servlet technology, and are fully interoperable with servlets. JSPs have dynamic scripting capability that works in tandem with HTML code, separating the page logic from the static elements—the actual design and display of the page—to help make the HTML more functional (e.g., dynamic database queries). One can include output from a servlet or forward the output to a servlet, and a servlet can include output from a JSP or forward output to a JSP. JSPs are not restricted to any specific platform or server, which helps their performance in the context of widely distributed, heterogeneous computing systems such as the management computing system 115 might be in some embodiments.

However, the rendition of the data is decoupled from the control and data, and could be replaced by another presentation interface. As those in the art having the benefit of this disclosure will appreciate, different types of data may be more amenable to rendition in one format or interface type than another. Thus, while the illustrated embodiment renders the data into a Web page in a GUI, other embodiments may render the data in a different interface or format. Alternative embodiments might render the data into a WORD or EXCEL document in a Disk Operating System (“DOS”) interface, for example. Similarly, the data may be represented in tabular form, as free text display, as an image, or as some other graphical object, depending on the nature of the information.

The presentation by the presentation tier 509 therefore transforms the data held in the response form 409 into a user interface on the client machine, i.e., a user station 130. In the illustrated embodiment, the presentation interface transforms the response form 409 data into a hypertext markup language (“HTML”) web page, as discussed above. The presentation tier 509 uses tools, e.g., the presentation renderer 518, to create graphics and images from data definitions held in the data form 409. These graphics are usually client side rendered and stored image files and image maps that are loaded into the Web browser 342.

The application controller 406d delegates authority to the proper function tools (not shown) within the information composition and analytics tier 512, based upon received requests. The application controller 406d holds the knowledge of which tools work together to produce information for a specific context, or report. Each request maps to a servlet view as defined through the configuration file (i.e., application controller 406d), and the action class for that servlet view is designed to call the appropriate DAM interfaces and analysis routines. The information composition and analytics tier 512 comprises toolsets, such as the data mining algorithms 506, for determining assessments and hypotheses for a given context. These toolsets use the data access objects 503 produced by the data access tier 515 and the data mining algorithms 506 to construct this information.

Each analysis routine and algorithm, and data mining algorithm is tailored for the specific analysis to be performed. Statistical data mining generally includes classification algorithms such as decision trees and cased-based (non-parametric) learning. These include regression algorithms such as multivariate polynomial regression, local-weight regression and they include other data mining operations such as clustering. For example, algorithms were developed to find part failure correlations from a service history database, cumulative failure rate trends from a maintenance database, repair time statistics from a service database, etc. The particular algorithms employed in any given embodiment will be implementation specific, depending on a number of factors such as the type of management decisions to be made, the nature of the assets 106, the type and amount of data available. This list is neither exhaustive nor exclusive. Alternative embodiments may employ other considerations in addition to or in lieu of these. The identification of such considerations and the development and implementation of such algorithms should readily be within the ordinary skill in the art for those in the art having the benefit of this disclosure.

The data access tier 515 functions as the interface to the information 400 held in the various repositories. The methods and utilities in this layer transform data requests into data objects that can be acted upon and manipulated by other tools and applications. Each data repository in which the information 400 is stored, e.g., the data 400a-400c, is defined as a data source, which describes the location and access protocol to the information 400. Retrieval functions were written, that map a data source to a retrieval request (usually a structured query language (“SQL”) query string) to an action object result, or set of action objects as the result. The retrieval request is fulfilled on the data source and the results are marshaled into the specified actionable objects, which are passed back as the result of the data access request.

No part of the APS system 133 in this particular embodiment acts on raw information. Instead, information is encapsulated in the data access objects 503. This makes for easy transition to other data sources, as only the data access tier 515 needs modification, while the remainder of the modules 406b-406d continue to use the same data access objects 503 they previously had been using. This allows for the data source to be modified and/or the retrieval request to be modified without affecting the consumers of the data access request. This is because the same type and format (not necessarily number) of result action objects are still defined to be returned. Even the implementation details of the action objects themselves can be modified without affecting the data access request consumers, because the action object interface description is not modified and remains the constant point of interaction.

Each tier of the application architecture 500 provides mechanisms (not shown) to be accessed and utilized by external systems. In this way various levels of functionality within the APS system 133 can be exposed to other systems, as needed, thus promoting free and open information exchange. Each tier of the APS application in total (except for the presentation tier 509) can be bundled as a library and used to produce the same results it is responsible for, without going through the application controller. The module packages and classes do not have any software dependencies on the controller.

One such external system is the simulator 136. Many important questions of the user involve not the past but the future, such as the impact of a particular decision, or of a change in historic patterns. Because of the stochastic nature of future operations, the APS system 133 uses simulation extensively. The simulator 136 analyzes and predicts the behavior and effect of different business rules and constraints on the growing number of asset configurations, their technical age, capability, reliability, and cost to maintain. Users can tune existing parameters to evaluate alternatives and their effectiveness compared to current conditions. The results can help guide decisions on events such as service procedures, retrofits, and technology upgrades. To this end, the APS system 133 leverages several key components: an information architecture for data analysis and composition, algorithms for simulating failure events and sustenance procedures, and an open standards based architecture.

The simulator 136 uses, as inputs, a current profile for each asset 106 in the simulation and the results of the ongoing analysis of historical data. The current profile may comprise stored information 400, shown in FIG. 4, drawn from the tactical data net 112, first shown in FIG. 1, or some combination of the two. The simulator 136 differentiates between conditions-variable characteristics of the operation over which the user has no control-and policies, which are those aspects of the operation that involve decisions. Special entities (not shown) are employed which simulate the ongoing behavior of human decision-makers in the system, such as technicians who select one of a number of available replacement parts for a particular breakdown. These policy-selectors are established at the start of each run and can range from very naive to quite sophisticated. A naïve policy selector might, for instance, might always replace a broken or worn part with the cheapest available part. On the other hand, a sophisticated policy-selector might use complex scoring functions, which may be established by the user or through the use of multiple simulation runs.

The simulator 136 allows the APS system 133 to project asset visibility into the future. The simulator 136 reports various operational and contract metrics under a variety of conditions and policies. For example, exemplary metrics may include, but are not limited to, cost, equipment availability, turn around time, mean time to repair, etc. FIG. 6 shows the asset availability metric as it is measured and evaluated by the service contract. It shows how often a pre-determined percentage of assets will be available over a pre-defined window of time. This view is also known as the “90-90 view”, since most often it is used to determine if 900/0 of the assets are available 90% of the time.

The simulator 136 can be initiated either manually by a user or can be set to run automatically at scheduled time intervals, or in response to changes in conditions. In the case of manual initiation, the simulator 136 lets the user evaluate specific “what-if” situations by letting the user adjust numerous simulation parameters. However, the user may also benefit from simulation runs that are done automatically, varying conditions and policies to obtain a wide range of scenarios that are then probed and evaluated. Reports from these automated simulation results are saved so that the user can peruse through them at a more convenient time, or they may be brought to the user's attention in cases where negative trends or favorable opportunities are identified.

More particularly, the simulator 136 is a discrete-time simulator. A variety of discrete-time simulators are known to the art, and any suitable discrete-time simulator may be used. In the illustrated embodiment, the simulator 136 is a discrete-time simulation environment suitable for examining the behavior of large populations whose characteristics can be modeled using a semi-Markovian process and is specialized to allow for ease of analysis for logistics. Note, however, that alternative embodiments may be employed that implement supervisory elements and state transitions in ways very different from semi-Markovian models.

The semi-Markovian model typically involves a population of logistical entities (parts, subassemblies, units, etc.) that may have any number of sub-entities. The simulator 136 includes a process to map logistical processes to a generic semi-Markovian model, the simulation engine itself, a user environment to allow user-driven what-if analysis of different logistic strategies, and the analytical processes that generate information-rich output vectors. These features enhance the decision making process by providing flexible and situational support for forecasting impacts of various strategies on future logistical operations.

The simulator 136 allows the user to define supervisory elements in the simulation and rules for them to follow. Other kinds of changes are under the control of others, or are uncontrolled, such as the characteristics of newly-designed parts, market forces which might impact costs, and utilization levels. Within the simulation, these transitions are governed by probability distributions which may be either determined by fitting the data or by user specification.

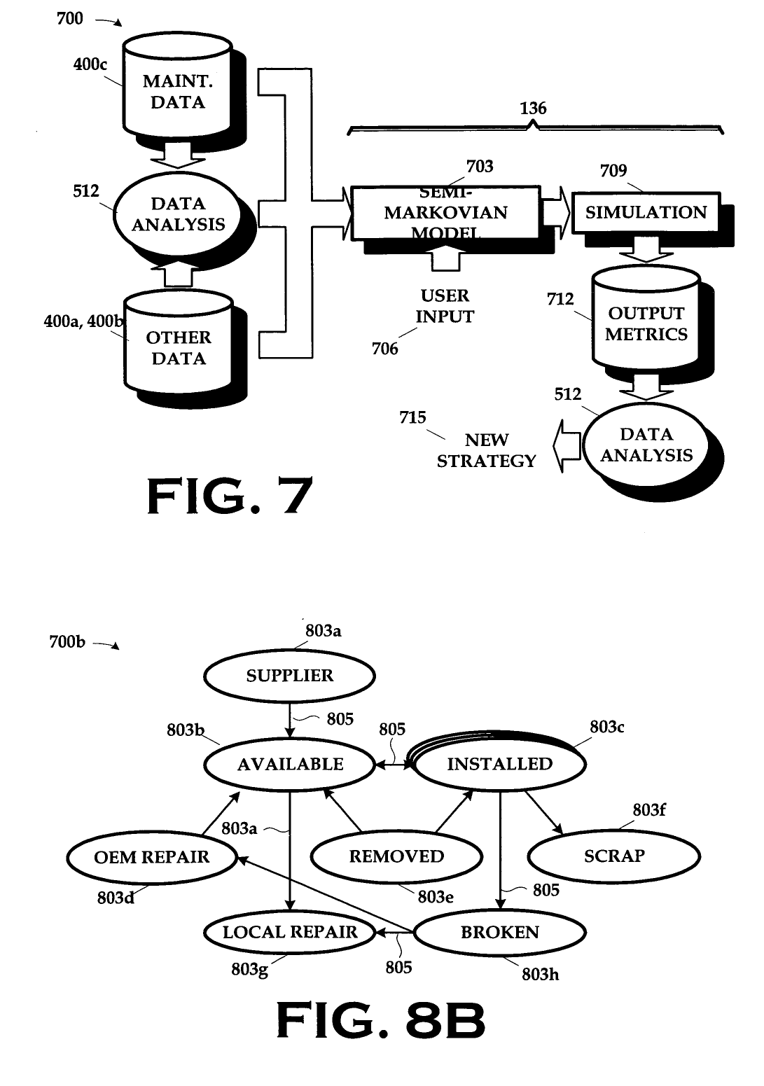

The simulator 136 includes four major components: a process for mapping a scenario to a semi-Markovian model; a process and environment for user-directed what-if analysis; the simulation algorithm; and the post-analysis algorithm. The semi-Markovian model is appropriate because the probability of many transitions is not time-independent. Utilization levels, for example, may change over time, affecting failure rates. The high-level process 700 is shown graphically in FIG. 7. As shown in FIG. 7, the semi-Markovian model 703 receives the user input 706 indicating the scenario to be simulated. The semi-Markovian model 703 retrieves data from a number of sources, e.g., the information 400 from the operational data 400a, service data 400b, and maintenance data 400c, some of which may be preprocessed to some degree. The simulation 709 is performed by applying the semi-Markovian model 603 over time to produce a variety of output metrics 712 that can be analysed to formulate a new strategy 715.

Many characteristics of the semi-Markovian model 703 can typically be obtained from existing databases. Once the data fields have been mapped to the required inputs, the relevant data is analyzed and appropriate inputs are generated. When data is missing, extremely sparse, or equivocal, default characteristics are assumed. The user may at any time alter the model or its characteristics, but user input 706 is not required to create the model. The semi-Markovian model has two aspects, which are modeled differently within the simulation.

There are at least two aspects of the semi-Markovian model. One aspect of the semi-Markovian model is the network of states that the data of interest traverse. Consider a scenario in which the semi-Markovian process 703 is modeling the use of parts for a fleet of vehicles. The simulator 136 (i.e., the semi-Markovian process 703 and the simulation 709) encompasses high-cost and/or critical parts throughout the operational, maintenance and sustainment processes, and thus is able to reflect part reliability and many diverse sources of variability. Two alternative networks 700a, 700b for a single part (not shown) are illustrated in FIG. 8A-FIG. 8B. Each node 800a-800f, 803a-803h corresponds to a state (e.g., AVAILABLE, INSTALLED, SCRAP, etc.), with semi-Markovian (not necessarily time-independent) transitions 805 between the states. Some states have a temporal element, which allows parts to age within a state until a transition occurs. The other aspect focuses on the relationship of the lowest-level entities to the fleet being managed:
Fleet
   Subgroups (0 or more levels)
      Individual Units (1 level, required; these entities have availability to the customer, e.g., airplanes, locomotives, . . . )
         Assemblies and Subassemblies (O or more levels)
            Parts (1 level, required; these are the things that fail; in some situations, parts may be synonymous with individual units)
               Note that this relationship is exemplary only. The content and definition of the relationship will be implementation specific. Thus, alternative embodiments may employ relationships other than that set forth above.

There is no requirement for symmetry. A fleet 103 may be divided into regional groups, some or all of which may be further subdivided into subgroups; alternatively, a fleet could consist of some individual units and some subgroups. For example, as shown in FIG. 9, the assets 106 of the fleet 103 within the theater of operations 109 can be divided into two regional groupings 900a-900c. Note that the regional groupings 900a-900c could be subdivided into subgroups and that the single assets 106 of the regional grouping 900c could be considered unattached from any regional grouping in alternative embodiments. Similarly, an individual unit could consist of some parts and some assemblies that are further composed of multiple levels of subassemblies. Ultimately, however, everything consists of parts. These relationships are modeled with supervisory elements, which are also used to implement policies and rules that reflect the actions of humans within the logistics network.

The model allows for a large range of complexity. For example, a node in the network may be capacitated (such as a repair facility which can only work on so many parts at a time). In such a case the repair node in the simple network shown is replaced by a sequence of two nodes, one representing the queue of broken parts and the other, capacitated node representing the active repair facility. Alternatively, there may be an inspection operation, from which a part could be sent to any one of a number of repair facilities (or scrapped). There are a large number of supervisory capabilities built in to the simulator as well. Such supervisory elements implement various rules or policies, such as priority queues which select the next broken part to work on, or shipping selectors which determine what shipping protocol should be used for a particular part or group of parts. The roll-up of parts into individual units includes supervisory capabilities as well, to handle things like selecting which of two or more interchangeable parts should be installed in a particular unit.

In operation, context driven interrogation mechanisms implemented by the metric evaluation applications 203, shown in FIG. 2, extract inherent relationships between information to generate the visual information sets 403. This is accomplished by sharing data parameters between different data presentation elements of a specific page context, i.e., an actual rendering, e.g., a JSP in a particular context. When a shared data parameter (i.e., a parameter shared by different forms in the same rendering) is changed within a page context, then all data presentation objects (e.g., data access objects 503 pushed forward for presentation) that use that parameter change with the same respect. The ICM 406c uses the single request parameter from the application controller 406d and passes it to the various DAM 406a methods and/or LAM 406b methods for each of the affected presentation objects.

These extracted information sets 403 may include situational assessment and recommended course of action, and provide the supporting information used in formulating any hypotheses. These information sets 403 may also provide supporting information used in formulating any hypotheses. Users navigate the composed information and situational context through intuitive region of interest (“ROI”) selections, to gain more information for supporting operations and business process decisions. The presentation renderer 518 of the presentation tier 509 of the APS system 133 renders each ROI area as a hyperlink, with request context parameters that are sent to the application controller 406d when selected by the user.

Thus, the APS system 133 creates context based information sets 403 from maintenance and service information 400 obtained from the data stores 138. In the illustrated embodiment, such information may also be obtained over the tactical data net 112. The information sets 403 contain relevant data for a given context for a given asset 106. The information sets 403 are composed in both textual and graphical form. FIG. 6A is an illustrative display 600 of such an information set 403 in the form of a screenshot overlaid with textual explanation. Graphical summaries of the relevant information, such as the display 600, act as navigation tools for the information set 403, and control between information sets 403 changing the context. Graphical objects that are tagged as navigable are rendered with an image map (constructed from the meta-information from the data form) which define clickable regions of the graph, which are hyperlinked to the application controller 406d with specialized request parameters, to change the context of the information. The user(s) then employ the information sets 403 to navigate through changing contexts that might arise as a consequence of a decision they might implement.

An integral part of the APS system 133 in this particular embodiment is total asset visibility. Not only must the current and historical status of every asset be known, but the historical data must be constantly analyzed. This analysis, among other benefits, allows the system to determine that information which is most relevant given a situation or context and to display the most volatile results prominently.

Information is presented with the APS system 133 in a hierarchical fashion with the most aggregate view of information presented first, and the ability to drill down into the various sub levels. The DAM 406a defines a set of actionable objects, (i.e., the DAOs 503), representing the information hierarchy (the number and type of sub objects, and attributes for the current level). When accessed, the DAM 406a methods return the populated objects for a given hierarchical level. The contents of these action objects are rendered in the presentation tier 509. For example the APS system 133 follows the hierarchy of first a fleet view, followed by a view of a specific location, followed by a view of an asset at a location, and finally of the parts on that asset.

These perspectives enable total asset visibility, by providing detailed information specific to each context. Along with this hierarchical navigation scheme of asset information, information domains are divided up and presented on different report pages. The report layouts share data parameters across multiple data presentation objects (“DPOs”) 505 of the report. The data represented by the graphical presentation objects can all come from the same source or from separate sources, but each presentation object has its own complete graphical dataset so that it can be rendered correctly in the presentation tier 509. Graphical presentation objects cannot share data series information, i.e., a group of related data points, such as a related sequence (order is important) of data. Such as a time series; For example, the total value of parts used for each month of the year would be a data series. Report layouts provide complete listings of the information driving the report and the key attributes for each report domain are summarized and aggregated graphically. See FIG. 6B, which is a screenshot 610 of such information. The visual summaries provide insight into the information presented in the report, quickly and intuitively, without the users having to interact with the report to find out the information.

The graphical summaries within the APS system 133 also provide a means of navigation and context drill down into the information presented. Users navigate the composed information and situational context through simple intuitive region of interest (“ROI”) clicks, to gain more information for supporting operations and business process decisions. The presentation tier 509 of the APS system 133 renders each ROI area as a hyperlink, with request context parameters that are sent to the application controller 406d when selected. Graphical objects that are tagged as navigable are rendered with an image map (constructed from the meta information from the data form) which define selectable regions of the graph, which are hyperlinked to the controller with specialize request parameters, to change the context of the information. FIG. 6A is a screenshot of the APS application where a decision maker is presented with information about the different configurations of the managed assets, including number and location of configurations, similarities and distinctions among them, and a recommendation on how to reduce the total number of configurations of the assets. Through interaction with the elements of this report, a user can drill down to change the context of the information presented, in support of a more specific or fine-grained case, such as the reliability of a new configuration introduced recently at a single location.

The highlighted graphical component alerts the user as to the current context of information presented. Interacting with any of the graphical objects dynamically changes the information presented on the page. This exposes new and different relationships between the information sets 403. The presentation tier 509 of the framework renders each ROI area as a hyperlink, with request context parameters that are sent to the application controller when clicked. Graphical objects that are tagged as navigable are rendered with an image map (constructed from the meta information from the data form) which define clickable regions of the graph, which are hyperlinked to the application controller 406d with specialized request parameters, to change the context of the information. By providing these intuitive “point-and-click” interaction mechanisms we allow the user to find answers to their questions about current and historical field performance, and to explore the data and perform their own feature selection and data mining.

The user interfaces with the simulator 136 via a graphical interface that displays the simulation initial conditions, runtime model parameters, and simulation output information. All information is divided up into tabbed page sections within the user interface. Each page contains the information relevant to that particular section (part reliability, local repair facility information, vendor information, etc.) Initial conditions and model parameters are displayed using simple tree view and table widgets. The simulation outputs are a history of the events occurred during simulation execution. The outputs are displayed as tables of aggregate event statistics, as well as translated into predefined contract fulfillment metrics (system availability, maintenance turnaround time, life cycle cost, etc.) The interface allows users to input and edit initial conditions and runtime model parameters so that multiple simulations may be run to perform “what-if” tradeoff analysis of model variables.

The discrete-time simulator 136 steps through time tracking the parts through the state network. Each event that affects the performance metrics is tallied, with roll-ups through subassemblies, assemblies, individual units, and subgroups to the entire fleet. At the conclusion of a single run of the simulation, the tallies are further analyzed to provide an output vector of the user-chosen performance metrics together with a corresponding set of simulation metrics. These simulation metrics are then analyzed by the simulator 136 to identify problems and opportunities related to the performance metrics. The output vector and its associated analysis are the keys to the user being able to devise a new strategy that better meets the performance metric objectives.

In general, the simulator establishes the expected behavior of the system. When the ongoing data analysis detects a change in the parameters describing the incoming data, the simulation is automatically run again to determine if different policies should be put into place, either to achieve contract benchmarks, or to achieve a cost savings. If the simulator is unable to determine a successful policy under the new conditions, the user is informed, and the user can then examine the policies that have been tried by the simulator, and propose additional ones to be evaluated. In the course of this analysis, the user may learn, for example, of a potential cost savings via inventory reduction, or that one version of a particular part is more or less reliable than others. The simulation can also be used to facilitate mission planning, determining, for example, how many spares should be shipped out with a unit that anticipates a given utilization rate, and which will not be re-supplied for a given period of time. The simulator further enhances the APS system 133 by allowing the user to evaluate the impact of various decisions without disrupting operations. The benefits of the simulation are varied.

Resulting as a favorable byproduct, repeated runs of the simulation using various policies can also help the user determine which variables in the system are worthy of closer attention and which ones can be overlooked. For example, the user of the simulation might infer, after a few simulation runs, that focusing on shipping policies for broken parts between locations and vendors has little to no effect on the overall efficiency and operating costs of the system. The user can then turn his attention to tweaking other more important parts of the system process.

The APS system 133 is used in one particular embodiment to track and monitor the performance of maintenance and service operations for over forty high value military assets, and will grow to over 800 such assets over the next 30 years. The APS system 133 is used to provide the current and historical information of fleet management performance, exposing relationships, trends, and correlations between operation policies, theater locations, and training levels. Logisticians and maintainers use the results of the APS system to more efficiently manage their operations. Decisions on operator training, maintenance policies, re-supply policies, and configuration management are all supported by the APS system 133.

The APS system 133 has proven itself to be a valuable resource for fast, easy-to-use visual analysis of information. Several different views of relevant Information are presented at once, increasing the speed and simplifying the access to the desired information. Interactive graphical data visualizations enable users to easily explore and understand data-for finding the patterns, relationships, and exceptions. Information is consistent and related throughout the various views of the system. Color schemes, graph types, information position are all consistent factors that allow for users to become familiar with the information quickly and easily, and over time lead to faster discovery or digestion of information, significantly increasing productivity, enabling better business decisions.

The APS system 133 provides report layouts with complete listings of the information driving the report, and graphical summaries of the key attributes for each report domain, as well as generated alerts, assessments, and recommendations based upon the information. Information is presented in a hierarchical fashion, providing total asset visibility of the components. The graphical summaries provide a means of navigation and context drill down into the information presented through simple intuitive ROI clicks, to gain more information for supporting operations and business process decisions.

The presentation tier 509 of the APS system 133 renders each ROI area as a hyperlink, with request context parameters that are sent to the application controller 406d when selected. Graphical objects that are tagged as navigable are rendered with an image map (constructed from the meta information from the data form) which define clickable regions of the graph, which are hyperlinked to the application controller 406d with specialize request parameters, to change the context of the information. The simulation capabilities of the APS system 133 allow for “what-if” scenarios to be tried and decision trade-offs to be tested and measured before implementing any policy changes in the field. These features make the APS system 133 a better decision support tool, by allowing faster, easier access to data, more complete knowledge of situations and their relationships, and ability to test decisions for effectiveness before implementing them.

Pertinent information about historical and current asset health and operation is displayed so that uses are able to get information needed to support decisions concerning the maintenance and upkeep of the assets. Trends, predictions, and recommendations give users further insight as to whether the situations they are observing are normal or need attention. Recommendations are generated by the APS system 133 by using the historical information and pre-defined goals and objectives. These recommendations are presented with the supporting evidence driving the recommendation so that users are aware of the situational context for which the recommendation was made, can see and interact with the data that ultimately drove the recommendation, so that they can act on the situation with more confidence.

Using visual data navigation, the present invention provides intuitive extrapolations and summaries of information to users, allowing them to see relationships and correlations, while still providing supporting evidence (in the form of tables and graphs). The information is interactive, allowing users to refine the context of information easily and responsively. In this way the results produced are rich and useful.

The sustainment process simulation provides maintainers and commanders the ability to forecast the impact that decisions and policy changes have on their ability to effectively manage a fleet of assets, and any impact that might have on contractual obligations or incentives. In this way trade-offs can be analyzed and “what-if” scenarios can be tried before they are put into practice, effectively providing a safe test bed for all decisions.

The shared data file, used for initialization includes building and populating the model and updating distributions from historical data and analysis.

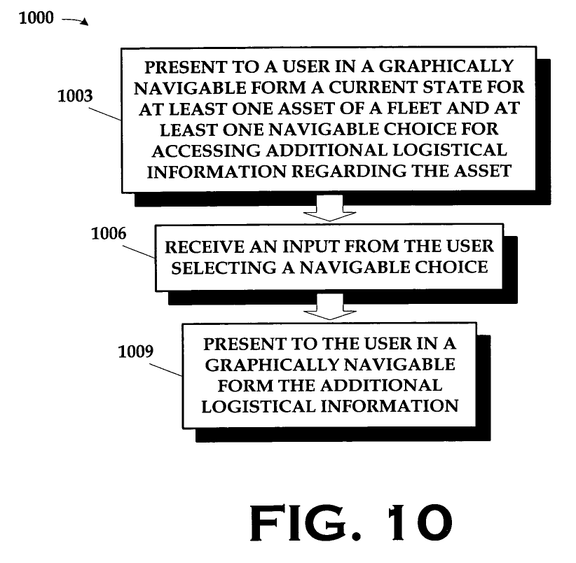

Accordingly, the present invention includes a method and apparatus for managing a fleet of assets and their associated logistics. FIG. 10 illustrate one particular embodiment of a method 1000 practiced in accordance with the present invention to manage, e.g., the fleet 103 of assets 106 shown in FIG. 1, all described more fully above. In this particular embodiment, a user (not shown) manages the fleet 103 through the management computing system 115. More particularly, the user invokes the method 1000 from a user station 130 and the method 1000 is then executed by the software-implemented APS 133 residing on the server 200, shown in FIG. 2. The APS 133 accesses the information stored in the data stores 138, obtained over the tactical data net 112, or acquired from some other data source during the implementation of the method 1000.

The method 1000 begins by presenting (at 1003) to a user in a graphically navigable form a current state for at least one asset 106 of the fleet 103 and at least one navigable choice for accessing additional logistical information regarding the at least one asset 106. The display 600, in FIG. 6A, is one such display. The display 600 presents information about the different configurations of the managed assets, including number and location of configurations, similarities, and distinctions among them, and a recommendation on how to reduce the total number of configurations of the assets.

The display 600 includes an image indicating distribution and location of various assets 106 of the fleet 103; operational information, i.e., alerts and status pertaining to the assets 106 in a tabular format; and a graphical format regarding the configuration of selected assets 106. The display 600 also includes un-navigable objects 603 and navigable objects 606. In general, the navigable objects 606 might convey, for instance, the current state of the fleet 103. The navigable objects 606 might narrow the context presented to the user from the fleet level to a number of assets 106 less than the entire fleet 103. Or, the navigable objects 606 might change the current context to a different aspect of logistical management, i.e., to a different domain, e.g., from domain D₁ to domain D₂, in FIG. 4.

Returning to FIG. 10, the method 1000 continues by receiving (at 1006) an input from the user selecting a navigable choice, e.g., a navigable object 606 in the display 600, shown in FIG. 6A. In the illustrated embodiment, the user makes the selection using standard GUI techniques, such as using the mouse 336, shown in FIG. 3, to move a cursor (now shown) over a navigable object 606 in the display 600 on the monitor 327. The choice is conveyed to the APS 133, shown in FIG. 1, over the communications links 140.

The method 1000 continues by presenting (at 1009) to the user in a graphically navigable form the additional logistical information. For example, the user might select one of the navigable objects 606 in the display 600, shown in FIG. 6A, and be presented with the display 610, shown in FIG. 6B. Note that the newly presented, additional logistical information may include additional navigable choices for accessing still other, additional logistical information. In this manner, the user can “drill up” or “drill down” through the logistical data.

At various points during the presentation of the logistical information, the user might invoke a prospective scenario for the given context. Invoking the scenario might include, for instance, simulating the prospective scenario and presenting to the user in a graphically navigable form the result of the simulation. In the illustrated embodiment, the simulation is performed as was discussed above relative to FIG. 7 and FIG. 8A-FIG. 8B. The point at which the simulation might be invoked and the subject of the simulation will be implementation specific. The manner in which the scenario is invoked will also be implementation specific. For instance, some embodiments might choose to offer a list of scenarios from which the user may select. Some embodiments might allow the user to call upon simulation when desired using a specific command. Some embodiments might permit both approaches. The user can thereby see the prospective effect of current conditions and operation or the consequences of prospective decisions.

Thus, the present invention presents an integrated business process to:
(i) aid the user in visually navigating logistic data with context dependent data displays to obtain relevant information and decision support for service and maintenance actions; and
(ii) support the expected evaluation of asset service and maintenance strategies using simulation and metrics-based evaluation.
   The latter process uses and builds upon the former process of assembling relevant and context dependent information. These processes combine visual navigation and context dependent data displays and analysis for creating relevant information and decision support using the APS system 133 for inputs to the discrete time event simulator and the outputs of the discrete time event simulator with metric evaluation for supporting the construction of strategies.

This combination enhances the decision making process by providing flexible and situational visibility into asset histories and providing support for forecasting impacts on the current situations from the strategies selected. Using these techniques, decision support processes and applications can allow users access to more information in support of specific job functions, faster and easier, and allow users to intuitively interact with the system to refine the context of information presented, to discover new relationships and features of information.

Thus, the present invention, in its various embodiments and aspects:
(i) provides decision makers, responsible for implementing the policies of service and maintenance for mechanical assets and their support organizations, with tools to gather data and inform on interesting aspects or areas of interest, so that the decision maker, policy definer are more informed and can make correct decisions regarding current state, based upon historical information, current state, and future implications.
(ii) gives the decision maker tools to inspect asset history information, inspect current state information; forecast future performance, qualify performance in terms of service agreement terms and conditions;
(iii) enable decision makers to see the future impacts of service and maintenance policy decisions through the use of simulation, and to allow decision makers the capability to perform what-if analysis on policy tradeoff variables;
(iv) facilitates the automated development and user modifications of the simulation model and to enable the user to examine the behavior of the simulation;
(v) provides information and feedback on the impact of strategy decisions;
(vi) facilitates the development of optimal strategies; and
(vii) enables updating the model and distributions in the simulation for strategy development and modification to accurately reflect expected changes.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A fleet management and logistics system, comprising:
an autonomic product support system capable of graphically presenting fleet data including logistical data regarding at least one asset within a fleet over time in a graphically navigable form to a user;
a simulator capable of simulating the effect over time of a prospective management decision regarding the asset over time and upon request of the user through the autonomic support system; and
a communications channel over which the user interfaces with the fleet data through the autonomic product support system.

2. The fleet management and logistics system of claim 1, wherein the autonomic product support system includes:
a data access tier responsible for extracting information from at least one data source and creating data access objects with the information;
an information composition and analytics tier responsible for analyzing and composing the data access objects into at least one data set;
an application controller that delegates authority to the a plurality of function tools within the information composition and analytics tier based upon received requests from the user; and
a presentation tier capable of rendering the analyzed and composed data into a graphical form and presenting the rendered data to the user.

3. The fleet management and logistics system of claim 2, wherein the data access objects are self-defining as navigable or un-navigable.

4. The fleet management and logistics system of claim 2, wherein the data source comprises at least one of a data store and a tactical data net.

5. The fleet management and logistics system of claim 1, wherein the simulator comprises a discrete time simulator.

6. The fleet management and logistics system of claim 5, wherein the discrete time simulator employs a semi-Markovian process.

7. The fleet management and logistics system of claim 1, wherein the communications link comprises at least one of a land-line and a wireless link.

8. A computing system, comprising:
a software-implemented fleet management and logistics system, including:
an autonomic product support system capable of graphically presenting fleet data including logistical data regarding at least one asset within a fleet over time in a graphically navigable form to a user; and
a simulator capable of simulating the effect over time of a prospective management decision regarding the asset over time and upon request of the user through the autonomic support system;
a user station through which the user interfaces with the autonomic product support system of the fleet management and logistics system; and
a communications channel over which the user interfaces with the fleet data through the autonomic product support system.

9. The computing system of claim 8, wherein the autonomic product support system includes:
a data access module responsible for extracting information from at least one data source and creating data access objects with the information;
an information composition and analytics module responsible for analyzing and composing the data access objects into at least one data set;
an application controller module that delegates authority to the a plurality of function tools within the information composition and analytics tier based upon received requests from the user; and
a presentation module capable of rendering the analyzed and composed data into a graphical form and presenting the rendered data to the user.

10. The computing system of claim 8, wherein the simulator comprises a discrete time simulator.

11. The computing system of claim 8, wherein the communications link comprises at least one of a land-line and a wireless link.

12. The computing system of claim 8, wherein the software-implemented fleet management and logistics system is implemented in open standards and open source technologies.

13. The computing system of claim 8, wherein the software-implemented fleet management and logistics system comprises a Struts-based framework.

14. The computing system of claim 8, wherein the software-implemented fleet management and logistics system resides on a computing apparatus other than the user station.

15. The computing system of claim 8, further comprising a plurality of computing devices associated with a plurality of the assets.

16. A program storage medium encoded with instructions comprising an autonomic product support system capable of graphically presenting logistical data regarding at least one asset within a fleet over time in a graphically navigable form to a user, including:
a data access module responsible for extracting information from at least one data source and creating data access objects with the information;
an information composition and analytics module responsible for analyzing and composing the data access objects into at least one data set;
an application controller module that delegates authority to the a plurality of function tools within the information composition and analytics tier based upon received requests from the user; and
a presentation module capable of rendering the analyzed and composed data into a graphical form and presenting the rendered data to the user.

17. The program storage medium of claim 16, wherein the data access objects are self-defining as navigable or un-navigable.

18. The program storage medium of claim 16, wherein the data source comprises at least one of a data store and a tactical data net.

19. The program storage medium of claim 16, wherein the encoded instructions further comprise a simulator capable of simulating the effect over time of a prospective management decision regarding the asset over time and upon request of the user through the autonomic support system.

20. The program storage medium of claim 19, wherein the simulator comprises a discrete time simulator.

21. The program storage medium of claim 16, further encoded with the data source.

22. A computing apparatus, comprising:
a processor;
a bus system;
a storage that communicates with the processor over the bus system and on which reside:
an autonomic product support system capable of graphically presenting logistical data regarding at least one asset within a fleet over time in a graphically navigable form to a user; and
a simulator capable of simulating the effect over time of a prospective management decision regarding the asset over time and upon request of the user through the autonomic support system.

23. The computing apparatus of claim 22, wherein the autonomic product support system includes:
a data access module responsible for extracting information from at least one data source and creating data access objects with the information;
an information composition and analytics module responsible for analyzing and composing the data access objects into at least one data set;
an application controller module that delegates authority to the a plurality of function tools within the information composition and analytics tier based upon received requests from the user; and
a presentation module capable of rendering the analyzed and composed data into a graphical form and presenting the rendered data to the user.

24. The computing apparatus of claim 22, wherein the simulator comprises a discrete time simulator.

25. The program storage medium of claim 22, further comprising data source including the fleet data residing on the storage.

26. A system, comprising:
a fleet of assets distributed across a theatre of operations;
a computing system, including:
a plurality of user stations through which a plurality of users may manage the assets of the fleet;
an autonomic product support system graphically presenting fleet data including logistical data regarding the assets over time in a graphically navigable form to the users;
a simulator capable of simulating the effect over time of prospective management decisions regarding the assets over time and upon request of the users through the autonomic support system from the user stations; and
a communications channel over which the users interface with the fleet data through the autonomic product support system.

27. The system of claim 26, wherein the fleet of assets includes at least one of a vehicle and a facility.

28. The system of claim 27, wherein the vehicle is one of a vessel, an aircraft, a spacecraft, and a truck.

29. The system of claim 27, wherein the facility is one of a repair facility, refueling facility, and a cargo lading facility.

30. The computing apparatus of claim 26, wherein the autonomic product support system includes:
a data access module responsible for extracting information from at least one data source and creating data access objects with the information;
an information composition and analytics module responsible for analyzing and composing the data access objects into at least one data set;
an application controller module that delegates authority to the a plurality of function tools within the information composition and analytics tier based upon received requests from the user; and
a presentation module capable of rendering the analyzed and composed data into a graphical form and presenting the rendered data to the user.

31. The computing apparatus of claim 26, wherein the simulator comprises a discrete time simulator.

32. The program storage medium of claim 26, further comprising data source including the fleet data residing on the storage.

33. A method for managing a fleet of assets and their associated logistics, comprising:
presenting to a user in a graphically navigable form a current state for at least one asset of the fleet and at least one navigable choice for accessing additional logistical information regarding the at least one asset;
receiving an input from the user selecting a navigable choice; and
presenting to the user in a graphically navigable form the additional logistical information.

34. The method of claim 33, wherein presenting the current state of at least one asset of the fleet includes presenting the current state of the fleet.

35. The method of claim 33, wherein the navigable choice narrows the context to a number of assets less than the entire fleet.

36. The method of claim 33, wherein the navigable choice changes the context to a different aspect of logistical management.

37. The method of claim 33, wherein the navigable choice invokes a prospective scenario.

38. The method of claim 37, further comprising:
simulating the prospective scenario; and
presenting to the user in a graphically navigable form the result of the simulation.

39. The method of claim 33, wherein presenting to the user the additional logistical information includes at presenting to the user at least one additional navigable choice for accessing additional logistical information regarding the at least one asset.

40. A program storage medium encoded with instruction that, when executed by a computing device, perform a method for managing a fleet of assets and their associated logistics, comprising:
presenting to a user in a graphically navigable form a current state for at least one asset of the fleet and at least one navigable choice for accessing additional logistical information regarding the at least one asset;
receiving an input from the user selecting a navigable choice; and
presenting to the user in a graphically navigable form the additional logistical information.

41. The program storage medium of claim 40, wherein presenting the current state of at least one asset of the fleet in the encoded method includes presenting the current state of the fleet.

42. The program storage medium of claim 40, wherein the navigable choice narrows the context to a number of assets less than the entire fleet.

43. The program storage medium of claim 40, wherein the navigable choice changes the context to a different aspect of logistical management.

44. The program storage medium of claim 40, wherein the navigable choice invokes a prospective scenario.

45. The program storage medium of claim 40, wherein presenting to the user the additional logistical information in the encoded method includes at presenting to the user at least one additional navigable choice for accessing additional logistical information regarding the at least one asset.

46. A computing apparatus, comprising:
a computing device;
a bus system;
a storage that communicates with the processor over the bus system; and
a software-implemented application residing on the storage than, when invoked by the computing device, performs a method for managing a fleet of assets and their associated logistics, comprising:
presenting to a user in a graphically navigable form a current state for at least one asset of the fleet and at least one navigable choice for accessing additional logistical information regarding the at least one asset;
receiving an input from the user selecting a navigable choice; and
presenting to the user in a graphically navigable form the additional logistical information.

47. The computing apparatus of claim 46, wherein presenting the current state of at least one asset of the fleet in the encoded method includes presenting the current state of the fleet.

48. The computing apparatus of claim 46, wherein the navigable choice narrows the context to a number of assets less than the entire fleet.

49. The computing apparatus of claim 46, wherein the navigable choice changes the context to a different aspect of logistical management.

50. The computing apparatus of claim 46, wherein the navigable choice invokes a prospective scenario.

51. The computing apparatus of claim 46, wherein presenting to the user the additional logistical information in the encoded method includes at presenting to the user at least one additional navigable choice for accessing additional logistical information regarding the at least one asset.
